(19) United States
(12) Patent Application Publication
(10) Pub. No.: US 2024/0109742 A1
(43) Pub. Date: Apr. 4, 2024

(54) METHOD AND DEVICE FOR STACKING FLAT ITEMS

(71) Applicant: GIESECKE+DEVRIENT CURRENCY TECHNOLOGY GMBH, Munchen (DE)

(72) Inventor: Frank NEUDEL, Freising (DE)

(21) Appl. No.: 18/553,877

(22) PCT Filed: Apr. 7, 2022
(86) PCT No.: PCT/EP2022/025136

§ 371 Date: Oct. 4, 2023

(30) Foreign Application Priority Data
Apr. 8, 2021 (DE) 10 2021 001 820.6

(51) Int. Cl. B65H 29/40; B65H 31/30; B65H 33/12

(52) U.S. Cl. CPC B65H 29/40; B65H 31/3027; B65H 33/12; B65H 2301/4452; B65H 2511/30

(57) ABSTRACT

A method and a device for stacking flat items in order to form stacks with a predefined number of flat items by means of a stacking wheel has the following steps: a) introducing flat items into compartments of the stacking wheel, b) transporting the flat items in the compartments of the stacking wheel, c) removing the flat items from the compartments of the stacking wheel and forming a stack with the predefined number of flat items, and d) removing the stack with the predefined number of flat items, wherein, after introduction of the predefined number of flat items into the compartments of the stacking wheel, no flat item is introduced into at least one subsequent compartment of the stacking wheel, and repeating steps a) through d).

The invention relates to a method and a device for stacking flat items.

The stacking of flat items, e.g., electrode elements, is known. In this case, at least a first electrode element and a second electrode element are used, which are arranged in a stacked position, thus producing an electrode stack. In this way, electrode elements for producing electrochemical energy stores, such as lithium-ion batteries or energy converters, such as fuel cells, are usually stacked—in particular, in the production of pouch cells—a widely used design of a lithium-ion rechargeable battery.

The electrode elements are usually designed as a cathode, based, for example, upon aluminum foil, and/or as an anode, based, for example, upon copper foil. The smallest unit of each lithium-ion cell consists of two electrodes and a separator that separates the electrodes from one another. An ion-conductive electrolyte is subsequently placed between the two electrodes after filling.

During the stacking process, the electrode elements are stacked in a repeating cycle of anode, separator, cathode, separator, and so on.

In addition to the remaining steps in the production of electrochemical energy stores or fuel cells, such as assembly or contacting, for example, the step of stacking is often the bottleneck in the production throughput during production.

Known methods for stacking the electrode elements are based upon a gripping arm of a robot which grips and positions the electrode element. According to previous knowledge, however, no further significant speed increases are to be expected here.

Further known methods apply to the formation of a stack on a rotating stacking wheel with which the electrode elements are deposited on an electrode stack.

To this end, WO 2020/212316 A1 describes a method for producing an electrode stack of anodes and cathodes for a lithium-ion battery of an electrically-driven motor vehicle, in which the anodes and the cathodes are conveyed into compartments of a rotationally-driven or rotationally-drivable stacking wheel, and the anodes and cathodes received in the compartments are conveyed to a tray by means of a rotation of the stacking wheel. Furthermore, stacking what are referred to as monocells is known from WO 2020/212317 A1. This is an electrode composite consisting of an anode and a cathode and separators for separating the electrodes.

To produce the electrochemical energy stores or energy converters, it is necessary to stack a predefined number of electrodes or monocells. To enable continuous operation of the stacking wheel, it is necessary to remove the stack consisting of the predefined number of electrodes or monocells from a support on which the stack is formed before further electrodes or monocells are transported by the stacking wheel onto the tray for the next stack to be formed and deposited on the stack already formed.

The object is to provide a method and a device for stacking flat items, with which a stack having a predefined number of flat items is produced continuously and without interruption.

This object is achieved according to the invention by a method and a device for stacking flat items with the features according to the independent claims.

The method according to the invention for stacking flat items in order to form stacks with a predefined number of flat items by means of a stacking wheel has the following steps:
a) introducing flat items into compartments of the stacking wheel,
b) transporting the flat items in the compartments of the stacking wheel,
c) removing the flat items from the compartments of the stacking wheel and forming a stack with the predefined number of flat items, and
d) removing the stack with the predefined number of flat items,
   wherein, after introduction of the predefined number of flat items into the compartments of the stacking wheel, no flat item is introduced into at least one subsequent compartment of the stacking wheel, and repeating steps a) through d).

The device according to the invention for stacking flat items by means of a stacking wheel for forming stacks with a predefined number of flat items has a transport device for transporting the flat items into compartments of the stacking wheel, for which purpose the transport speed of the transport device and the rotational speed of the stacking wheel are synchronized, a stripper for removing the flat items from the compartments of the stacking wheel, a tray on which the flat items removed from the compartments of the stacking wheel can be deposited and stacks with the predefined number of flat items can be formed, and a stack transport device for removing, one stack at a time, a stack with the predefined number of flat items from the tray, wherein the transport device transports the predefined number of flat items into the compartments of the stacking wheel in each case, and transports no flat item into at least one subsequent compartment of the stacking wheel in each case.

The invention is based upon the knowledge that a discontinuous filling of the stacking wheel, i.e., not filling one or more compartments with flat items for stacking, results in a longer period between adjacent compartments containing flat items.

The advantage of the invention is to be seen in particular in that this longer period can be used to remove a stack formed by means of the stacking wheel before a new stack is formed. As a result, the stacking wheel can be used without interrupting the supply of flat items for forming stacks.

Further advantages of the present invention can be derived from the dependent claims and the following description of an embodiment with reference to figures.

In the drawings,

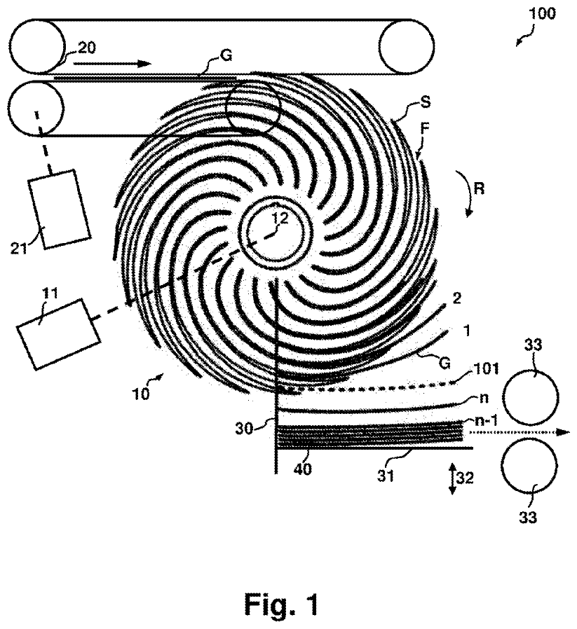

FIG. 1 shows an embodiment of a device for stacking flat items,

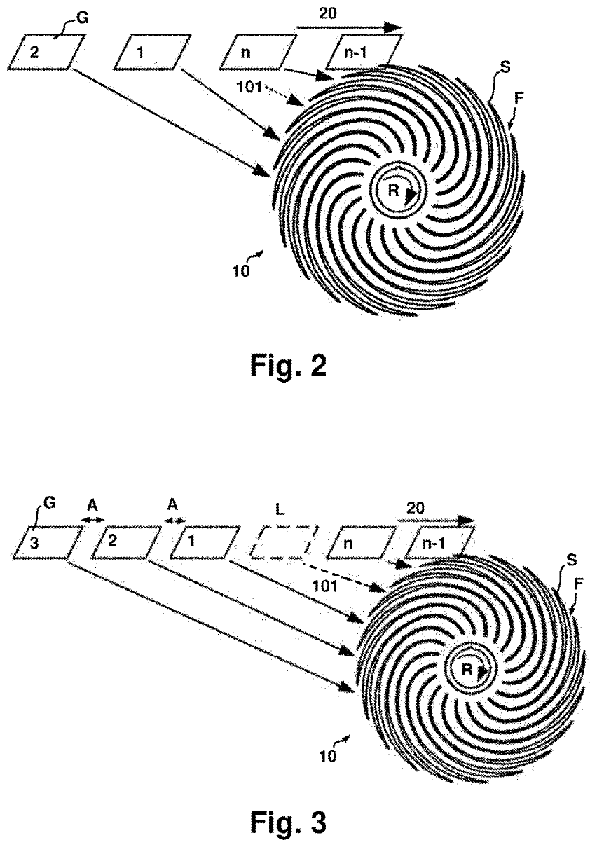

FIG. 2 shows a schematic representation of a first or second embodiment of the formation of stacks of flat items by means of a stacking wheel, and

FIG. 3 shows a schematic representation of a third embodiment of the formation of stacks of flat items by means of a stacking wheel.

FIG. 1 shows an embodiment of a device 100 for stacking flat items G by means of a stacking wheel 10, for forming a stack 40 with a predefined number n of flat items G. The number n can be any whole number—for example, 100.

The stacking wheel 10 shown has a predefined number of stacking fingers S—20 in the example shown. Adjacent stacking fingers S each include a compartment F according to the predefined number—20 in the example shown. A transport device 20, which is driven by a drive 21, e.g., an electric motor or a stepper motor, transports the flat items G onto the stacking wheel 10. The stacking wheel 10 rotates in a rotational direction R, driven by a drive 11—for example, an electric motor or a stepper motor. The drives 21, 11 of the transport device 20 and the stacking wheel 10 are synchronized with one another in such a way that the transport speed of the transport device 20 and the rotational speed of the stacking wheel 10 are coordinated with one another such that the flat items are introduced from the transport device 20 into the compartments F of the stacking wheel 10 without colliding with the stacking fingers. The device 100 for stacking flat items G also has one or more strippers 30, which are arranged to the side of the stacking wheel 10 and strip out, i.e., remove, flat items G transported in the compartments F, so that the flat items G are deposited on the tray 31 and form the stack 40 with the predefined number n of flat items G. If particularly large stacks 40 have to be formed, it can be provided that the tray 31 be able to be moved in the direction of the arrow 32 so that the stack 40 does not collide with the stacking fingers S of the stacking wheel 10. As soon as the stack 40 has the predefined number n of flat items G, the stack 40 is removed from the support 31 by a stack transport device 33 so that a subsequent stack can be formed.

FIG. 1 shows the moment at which the stack 40 with the predefined number n=100 is formed by flat items G, and the last flat item G, which is denoted by n, has been removed from the compartment, lying to the left of the stripper 30, of the stacking wheel 10. The finished stack 40 with 100 flat items G can then be removed from the stack transport device 33. To this end, it is provided that there be no flat item in the subsequent compartment of the stacking wheel 10, which is located in the region of the stripper 30 in FIG. 1 and is identified by the dashed line with the reference sign 101. This results in a time gap between the last flat item G of the stack 40, denoted by n, and the first flat item G, denoted by 1, of the next stack of flat items to be formed. This time gap allows the finished stack 40, which contains the number n of flat items, to be removed by the stack transport device 33 from the tray 31 without it colliding with the first flat item G, denoted by 1, of the next stack to be formed.

FIG. 2 is a schematic representation of a first embodiment for forming stacks with a number n of flat items G by means of a stacking wheel 10. In the first embodiment, it is provided that the rotational speed of the stacking wheel 10 driven by the drive 11 in the rotational direction R be able to be varied via an axis 12. The flat items G are thereby transported from the transport device 20 into the compartments of the stacking wheel 10. Once the last flat item G, denoted by n, which belongs to a stack with the number n of flat items G, has been transported into a compartment of the stacking wheel, the drive 11 increases the rotational speed, starting from the aforementioned rotational speed synchronized to the transport speed, such that no flat item is transported into the next compartment, marked with 101, of the stacking wheel 10 by the transport device 20. The rotational speed of the stacking wheel 10 is then reduced again to the synchronized rotational speed by the drive 11, and the first flat item, marked with 1, of the next stack to be formed is transported into the next compartment of the stacking wheel 10 by the transport device 20. After that, further flat items are transported into the compartments of the stacking wheel 10 until the predefined number n is reached. The rotational speed is then increased again, as described above, so that no flat item is contained in a compartment, in order to be able to remove the stack of n flat items from the tray 31.

FIG. 2 also includes a schematic representation of a second embodiment for forming stacks with a number n of flat items G by means of a stacking wheel 10. In the second embodiment, it is provided that the transport speed of the transport device 20 be able to be varied by means of the drive 21. The flat items G are thereby transported from the transport device 20 into the compartments of the stacking wheel 10. Once the last flat item G, denoted by n, which belongs to a stack with the number n of flat items G, has been transported into a compartment of the stacking wheel 10, the drive 21 reduces the transport speed, starting from the above-mentioned transport speed synchronized to the rotational speed, such that no flat item is transported into the next compartment of the stacking wheel 10 marked with 101 by the transport device 20. The transport speed of the transport device 20 is then increased again to the synchronized transport speed by the drive 21, and the first flat item, marked with 1, of the next stack to be formed is transported into the next compartment of the stacking wheel 10 by the transport device 20. After that, further flat items are transported into the compartments of the stacking wheel 10 until the predefined number n is reached. The transport speed is then reduced again, as described above, so that no flat item is contained in a compartment, in order to be able to remove the stack of n flat items from the tray 31.

It is also possible to combine the aforementioned variation of the transport speed and the variation of the rotational speed. The creation of vacant compartments between the flat items G from consecutive stacks in the stacking wheel 10 is then achieved by simultaneously increasing the rotational speed of the stacking wheel 10 and reducing the transport speed of the transport device 20.

FIG. 3 is a schematic representation of a third embodiment for forming stacks with a number n of flat items G by means of a stacking wheel 10. In the third embodiment, it is provided that a gap L of one flat item G be able to be created in the flow of transported flat items G. The transport speed of the transport device 20 and the rotational speed of the stacking wheel 10 remain unchanged. The flat items G are transported from the transport device 20 into the compartments of the stacking wheel 10. Once the last flat item G, denoted by n, which belongs to a stack with the number n of flat items G, has been transported into a compartment of the stacking wheel by the transport device 20, the gap L in the flow of flat items transported by the transport device 20 appears, so that no flat item is transported into the next compartment 101 of the stacking wheel 10 by the transport device 20. The first flat item, marked with 1, of the next stack to be formed is then transported by the transport device 20 into the next compartment of the stacking wheel 10. After that, further flat items are transported into the compartments of the stacking wheel 10 until the predefined number n is reached. As described above, a further gap L of one flat item G then appears in the flow of transported flat items G, so that no flat item is contained in a compartment, in order to be able to remove the stack of n flat items from the tray 31. The gap L can correspond to one or more flat items G or also fractions thereof. Instead of creating gaps L in the flow of flat items G by skipping individual flat items G, it is alternatively possible to reduce distances A between the flat items G in the flow of the flat items G, such that the required gap L is created after the predefined number n of flat items G.

It is also possible to combine the above-described variation of the transport speed and the variation of the rotational speed and the use of a gap in the transported flow of flat items. The creation of free compartments between the flat items G from consecutive stacks in the stacking wheel 10 is then achieved by increasing the rotational speed of the stacking wheel 10, reducing the transport speed of the transport device 20, providing gaps in the transported flow of flat items, or through a combination of two or all three of these measures.

The previous examples illustrated the situation in which a compartment in the stacking wheel 10 between the flat items G of two consecutive stacks of flat items G with the number n has no flat items, in order to create a time gap for the removal of a completed stack. It is obvious that the time gap can be increased as needed by the transport device 20 not transporting a flat item into more than one compartment. Two, three, four, five, or any number of compartments can thus remain vacant to create the desired time gap.

The compartments F of the stacking wheel 10 shown in FIG. 1 have a curved profile. Notwithstanding this, it can also be provided that the compartments have a rectilinear, helical, or other profile. The profile of the compartments is advantageously adapted to the properties of the flat items G to be stacked. If the flat items G are, for example, flexible and slightly bendable or malleable, it may be expedient to choose a curved or helical profile for the compartments. If the flat items G are, for example, rigid and only slightly bendable or malleable, or barely bendable or malleable, it may be expedient to choose a rectilinear or only slightly curved profile for the compartments.

The device 100 shown in FIG. 1 has a stacking wheel arranged on the driven axle 12. However, two or more stacking wheels 10 can also be arranged at a distance from each other on the axis 12 in such a way that the compartments F of the stacking wheels 10 are aligned with each other in the direction of rotation R, i.e., are oriented in such a way that the flat items can be transported by the transport device 20 into the compartments, which are all aligned with each other, of the stacking wheels. Furthermore, it can be provided that additional strippers 30 be arranged between the stacking wheels 20.

It can also be provided that, in addition to the tray 31 shown, a second tray or further additional trays be present. The tray 31 and the further additional tray or additional trays can then be brought selectively to the location of the tray 31 shown in FIG. 1 in order to receive flat items G. For this purpose, the second tray or further additional trays is or are introduced above the stack 40, formed on the first tray 31, and underneath the stacking wheel 20. The first tray with the stack 40 is then moved downwards in the direction of arrow 32 with the stack 40, and the second tray assumes the position of the illustrated first tray 31 in order to receive the next stack formed. Once the next stack is fully formed, the replacement of the trays is repeated, so that the tray 31 again receives flat items G for stacking. Alternatively, the first tray 31 can be pivoted with the stack 40 out of the area of the stacking wheel 20, and the second tray or further additional trays can simultaneously be pivoted into the area of the stacking wheel 10.

As described at the beginning of this description, the flat items G can be electrode elements for producing electrochemical energy stores, such as lithium-ion batteries, or energy converters such as fuel cells. These have anodes and cathodes and separators or membranes and are stacked individually or as monocells, as described for example in WO 2020/212316 A1 or WO 2020/212317 A1. A predefined number of anodes and cathodes as well as separators or membranes or monocells must be stacked in order to be able to form an energy store or an energy converter. This can be achieved particularly advantageously with the stacking wheel described above and the device equipped with the stacking wheel.

The stacking wheel described above, and the device equipped with the stacking wheel are also suitable for other flat items for which a stack is to be formed from a predefined number of flat items—for example, to form stacks of banknotes with 100 banknotes.

1.-9. (canceled)

10. A method for stacking flat items in order to form stacks with a predefined number of flat items by means of a stacking wheel, having the following steps:
a) introducing flat items into compartments of the stacking wheel,
b) transporting the flat items in the compartments of the stacking wheel,
c) removing the flat items from the compartments of the stacking wheel and forming a stack with the predefined number of flat items, and
d) removing the stack with the predefined number of flat items,
wherein, after introduction of the predefined number of flat items into the compartments of the stacking wheel, no flat item is introduced into at least one subsequent compartment of the stacking wheel, and repeating steps a) through d).

11. A device for stacking flat items by means of a stacking wheel, for forming stacks with a predefined number of flat items, having a transport device for transporting the flat items into compartments of the stacking wheel, for which purpose the transport speed of the transport device and the rotational speed of the stacking wheel are synchronized, a stripper for removing the flat items from the compartments of the stacking wheel, a tray on which the flat items removed from the compartments of the stacking wheel are deposited and stacks with the predefined number of flat items are formed, and a stack transport device for removing, one stack at a time, a stack having the predefined number of flat items from the tray,
wherein the transport device transports the predefined number of flat items into the compartments of the stacking wheel in each case, and in each case transports no flat items into at least one subsequent compartment of the stacking wheel.

12. The device for stacking flat items according to claim 11, wherein a drive of the stacking wheel increases the synchronized rotational speed of the stacking wheel so that no flat item is transported into the respective at least one subsequent compartment of the stacking wheel, and the synchronized rotational speed is then restored.

13. The device for stacking flat items according to claim 11, wherein a drive of the transport device reduces the synchronized transport speed of the transport device so that no flat item is transported into the respective at least one subsequent compartment of the stacking wheel, and the synchronized transport speed is then restored.

14. The device for stacking flat items according to claim 11, wherein a gap between flat items transported by the transport device is provided in each case after a number of flat items corresponding to the predefined number, so that no flat item is transported into the respective at least one subsequent compartment of the stacking wheel.

15. The device for stacking flat items according to claim 14, wherein the gap corresponds to at least one flat item or a multiple thereof.

16. The device for stacking flat items according to claim 14, wherein the gap corresponds to a fraction of a flat item.

17. The device for stacking flat items according to claim 11, wherein no flat items are transported into the two, three, four, or five subsequent compartments, respectively, of the stacking wheel.

18. The device for stacking flat items according to claim 11, wherein the compartments of the first and second stacking wheels have a curved, rectilinear, or helical profile along their profile or a section of the profile.
